(19) United States
(12) Patent Application Publication
(10) Pub. No.: US 2015/0275528 A1
(43) Pub. Date: Oct. 1, 2015

(54) METHOD FOR WORKING A USEFUL SURFACE OF A FLOOR COVERING

(71) Applicant: PROVERUM AG, Baar (CH)

(72) Inventor: Moritz MUEHLEBACH, Dietlikon (CH)

(73) Assignee: PROVERUM AG, Baar (CH)

(21) Appl. No.: 14/672,618

(22) Filed: Mar. 30, 2015

(30) Foreign Application Priority Data
Mar. 31, 2014 (CH) 483/14

(51) Int. Cl. E04F 15/04; B05D 3/12; B32B 38/00; E04F 15/02

(52) U.S. Cl. CPC E04F 15/04; E04F 15/02038; B05D 3/12; B32B 38/0012; B32B 38/145; B32B 2317/02; B32B 2317/16; B32B 2471/00

(57) ABSTRACT

A method for working a useful surface of a floor covering comprises the following steps: introducing structures into a planar cork material by way of a material-removing method, printing the structured cork material by way of a digital printing method, and applying a protective layer onto the printed structured cork material. On account of the method according to the invention, the visual appeal of the product may be influenced in a variety of ways. The visual impact may be significantly different from that of a smooth printed surface. On account of the combination of structuring and digital printing, in particular surfaces which display the impression of a non-sanded natural material (e.g. wood, slate, or similar) may be achieved.

### TECHNICAL FIELD

The invention relates to a method for working a useful surface of a floor covering. Said invention further relates to a floor covering which is manufacturable by such a method.

### PRIOR ART

Floor coverings having a useful surface from cork material have been known for some time. Said floor coverings often comprise cork floor boards which, apart from the useful surface from cork, display a substructure which is substantially dimensionally stable and which is provided with tongue or groove elements, respectively, such that the cork floor boards can be readily assembled to form a cork floor. Furthermore, floors in which the cork floor boards are adhesively bonded directly to the substrate are also known.

For the manufacture of the useful surface a planar cork material is initially manufactured. To this end, cork, for example remnants from the manufacture of bottle corks, is ground to form a granulate and subsequently compressed together with an adhesive under heat. Cork layers of the desired thickness are produced from the created material blocks by peeling. Said cork layers may then be interconnected, or connected to layers from other materials, respectively, to form a multi-layered floor covering.

On account of the modest thermal conductivity of the cork material, cork floors always feel warm and, on account of their elasticity, offer good tread comfort. However, on account of the material used, the visual appeal of a conventional cork floor is largely predetermined and cannot satisfy all requirements.

It has thus already been proposed for cork floor boards to be printed. In this manner, EP 1 990 186 A2 (E. Lingg) proposes that a highly compressed cork overlay is initially tempered at at least 150° C., then to adhesively bond said cork overlay to a damp course and to an HDF supporting board and compress the former with the latter, to sand and to prime the surface, then to apply a water-based UV-curing varnish using the digital printing method, and to finally apply at least two sealing layers. In this manner it is made possible for the cork floor boards to display another visual appeal, for example that of a wood or rock surface.

Printed cork floors are commercially available. The quality of printing is considerable but, on account of the smooth surface of the sanded cork layer, the surface does not have the impression which corresponds to that of a natural material, for example made from corresponding wood or rock material. This problem in part is addressed by applying thick structured varnish layers to the useful surface, wherein varnishes having various consistencies and various levels of gloss are employed. Another technique provides for post-working of a varnish layer in that a heated structured roller acts on the varnish layer, for example. However, not every desired visual impression may be achieved in this manner, particularly since the depth of the structures which are achievable in this manner is very limited. Furthermore, the durability of the structuring achieved in this way is questionable, and the methods are complex.

### DESCRIPTION OF THE INVENTION

It is an object of the invention to achieve a method for working a useful surface of a floor covering associated with the technical field mentioned at the outset, which achieves wider possibilities for influencing the visual impression of cork floors.

The achievement of the object is defined by the features of claim 1. According to the invention, the method comprises the following steps:
a) introducing structures into a planar cork material, by way of a material-removing method;
b) printing the structured cork material by way of a digital printing method; and
c) applying a protective layer onto the printed structured cork material.

In one preferred embodiment, the cork material used is a material which is substantially composed exclusively of cork and an adhesive. In other embodiments, the cork material may comprise other components; for example, this may be linoleum having a cork proportion, or so-called cork linoleum having an increased cork proportion, which components apart from cork comprise components such as linseed oil, natural resins, wood dust, pigments, jute and/or limestone.

The protective layer is, in particular, a sealing layer, or a varnish, respectively, having a water-based varnish, for example, which displays proportions of polyurethane and/or acrylic. The protective layer may also comprise, in particular, two or more layers of identical or different materials. Said protective layer has the task of protecting the printed layer and the planar cork material from damaging influences, and may also contribute toward a desired visual appeal of the surface of the floor covering.

Printing preferably is performed by way of an ink-jet printing method. As a non-contacting printing method, this is particularly well suited to printing the surface which is provided with the surface structure. Moreover, said ink-jet printing method can be employed cost-effectively and over a large area, wherein hardly any limits apply to the type of print to be produced. Suitable printing inks are dye-based and/or pigment-based UV-curing inks, for example.

On account of the method according to the invention, the visual appeal of the product may be influenced in a variety of ways. The visual impact may be significantly different from that of a smooth printed surface. On account of the combination of structuring and digital printing, in particular surfaces which display the impression of a non-sanded natural material (e.g. wood, slate, or similar) may be achieved. However, the invention is not limited to surfaces of this type; said invention is also suited to the manufacture of floor coverings which are not to impart the impression of a natural material.

By way of the method according to the invention a floor covering comprising the following is thus manufacturable:
a) a useful surface from a planar cork material, wherein the useful surface is provided with structures generated by a material-removing method;
b) a printed layer which is applied onto the structured useful surface; and
c) a protective layer which is applied onto the printed layer.

Advantageously, a thickness of the planar cork material is 1 to 5, preferably 2 to 4 mm. Cork which is suitable for useful surfaces of a floor covering and having such thicknesses is generally available.

Advantageously, the floor covering further comprises a dimensionally stable layer onto which the useful surface is applied. The dimensionally stable layer is, in particular, a high-density fiber board (HDF). The useful surface may be applied directly onto the dimensionally stable layer, or intermediate layers may be present. A preferred construction of the floor covering, for example, comprises from bottom to top a cork sub layer having a thickness of 1 to 2 mm and an antibacterial layer; this sub layer primarily serves for damping tread. Next, there is a highly dense fiber board having a thickness of 7 to 10 mm, then the planar cork material which forms the useful surface (e.g. having a thickness of 3 mm), then the printed layer, and finally the protective layer. Other layered constructions are based on a plurality of cork layers which are adhesively bonded to one another.

As an alternative to a layered construction, the invention may also be applied in the context of cork panels which themselves display a certain dimensional stability, which have a thickness of 5 mm or more, for example, and which are adhesively attached as such across their entire area.

In one preferred embodiment of the invention, the floor covering comprises a plurality of boards, wherein the dimensionally stable layer in peripheral regions of the boards comprises mutually interacting fastening elements. The fastening elements are, in particular, tongues and grooves, which enable fastening of adjacent boards by way of a so-called click connection. Corresponding geometries, in particular of laminate flooring, have been known for some time.

Preferably, the structures comprise structural elements having a depth of 0.05 to 2.0 mm. Structures of this type achieve the desired visual effect, do not have negative influences on either the useful properties of the floor-covering surface nor on printability. Structures having a depth of 0.1 to 0.5 mm are particularly preferred. In particular, the structures may be formed exclusively from such structural elements. However, it is also possible for further elements, in particular such of shallower depth, to be additionally present.

Preferably the structures comprise elongate structural elements having a width of 1 to 30 mm. An elongate structural element here is understood to be an element of which the shape comprises a substantially linear main extent, wherein a length (along this main extent) is considerably greater than a width which is transverse to the main extent, for example is at least 6 times greater. Structural elements having widths of 1 to 30 mm may be produced in a comparatively simple manner, for example by routing, sanding or planing operations, they correspond to structures such are often prevalent in natural materials (e.g. wood, rock), and they achieve a visual impact which is clearly different from that of a merely printed but otherwise smooth surface.

The structures may display further or other structural elements. Ultimately, the dimensions depend on the structuring method used and the desired visual impression.

Advantageously, the material-removing method here acts only in regions on the planar cork material, that is to say that another part of the useful surface corresponds to the original, substantially even surface of the cork material. Removal takes place in regions or even in only a punctiform manner. On account thereof, material-removing working of the cork material is simplified, the loss in thickness is minimal, and a surface which corresponds to an even face having depressions which have been introduced is achieved. This is very similar to wood surfaces which have been worked in a rough manner.

Alternatively, the entire surface is worked using the material-removing method, wherein the structures result in that at various points working takes place in a different manner.

In the case of first embodiments of the method according to the invention, during printing a printed pattern which is aligned in relation to the introduced structures is generated. This establishes various possibilities: on the one hand, the printed image may be selected such that the visual impact is mutually reinforced by structuring and printing, for example in that a wood grain is initially structured and then also emphasized in terms of color. The structuring and the printed pattern may also be mutually complementary in that structured regions are not overprinted, or overprinted so as to be different from non-structured regions. For example, the impression of a tiled surface may be achieved if trough-like depressions which correspond to the grouting are introduced in the course of structuring and if the (non-structured or differently structured) areas between the depressions are overprinted using a tile pattern in the course of printing.

The structuring and the printed pattern may already be fixedly predefined prior to the floor covering being manufactured. During printing, attention is then merely paid to whether the printed pattern is correctly aligned in relation to the structuring. In one variant, the printed pattern is only generated once the structuring has been generated, in particular in that the structuring which has been generated is, for example, optically and/or mechanically detected, and the printing data is generated or modified depending on the detected data.

In second embodiments of the method according to the invention, during printing a printed pattern which is independent of the introduced structures is generated.

In this manner, a surface structure which corresponds to the structure of a natural surface may be generated, for example, while by way of printing, the colors of the natural surface are also reproduced. Furthermore, the structuring allows for a desired texture to be achieved, whereby geometrical patterns or lettering may be overprinted onto the surface, for example.

Preferably, the material-removing method is performed in a CNC-controlled manner. This enables flexible material removal with minimal changeover times. It is also possible for a random element to be incorporated in the CNC controller, such that every structuring generated is different from any other.

Preferably, the material-removing method is a routing, sanding, or planing method. It has been demonstrated that methods of this type can be applied to a planar cork material. They furthermore enable targeted control of generating the desired structures. The material composition and the manufacturing parameters of the cork material (grain sizes of the cork granulate, plastic proportion, compressive pressure and temperature) have to be adapted to the material-removing method used, where and when applicable.

Further methods, for example using wire brushes which act at a constant or variable pressure on the planar cork material, are also possible.

In one advantageous variant of the method according to the invention, during application of the protective layer, or in a subsequent step, a varnish layer is applied and structured. Structuring here may take place during application, in particular in that the application across the area takes place in an irregular manner. Said structuring may also be performed in a subsequent step, either in that the not yet touch-dry, deformable layer is structured, for example by way of a profiled roller, or in that the already touch-dry layer is made to be deformable, for example by way of temporary heating, a profiled roller also being employable here. In the last mentioned variant, the roller advantageously comprises a heating unit, such that heating and structuring may take place in one work step.

Structuring of the cork layer may thus be complemented by structuring the varnish layer, for example at two different orders of magnitude of size (pertaining to the depth of the structures and, if applicable, also to the extent of the structures in terms of area). In this manner, the visual appeal of the floor covering, but also its useful properties, if applicable, may optionally be influenced to an even greater extent.

In one preferred embodiment, the structures in the useful surface comprise straight, elongate, trough-like structures in a regular arrangement, wherein the arrangement is selected such that the peripheral regions of the boards at least in part, preferably everywhere, run along the trough-like structures. This results in the transitions between adjacent boards being practically invisible, since said transitions are integrated in the regular arrangement of the trough-like structures, and since the potentially visible joint is recessed in relation to the surface of the floor covering. This embodiment is particularly preferable in the case of boards which can be joined to one another by way of a click connection. The regular arrangement of the trough-like structures may simulate a tiled surface, for example, wherein the trough-like structures correspond to the grouting between the tiles. Particularly preferably, the board and the structures are dimensioned such that a plurality of the trough-like structures, corresponding to grouting between the tiles, traverse the board and intersect at an angle of less than 90°, while in the peripheral regions of the boards half of a grouting, which is complementary to the corresponding half of a grouting of the adjacent board in order to form a complete grouting again, is in each case configured. Other geometries are possible, for example such in which only in the peripheral regions “half a grouting” is in each case configured. The visual impact may be amplified if the grouting region and the region lying therebetween are printed in a different manner during printing.

A trough-like structure here is understood to be a structure which generally runs along a straight line, which is recessed in relation to a surface of the useful surface, and which comprises a trough-like cross section which is substantially constant along the profile of the structure.

Further advantageous embodiments and combinations of features of the invention are derived from the following detailed description and the entirety of the patent claims.

### BRIEF DESCRIPTION OF THE DRAWINGS

In the drawings which are used for explaining the exemplary embodiment:

FIGS. 1A-E show vertical cross sections through a floor covering according to the invention, in various stages of manufacture;

FIG. 2 shows a schematic plan view onto the structuring of the floor covering according to the invention;

FIG. 3A shows a plan view onto a structured cork board for a floor covering according to the invention;

FIG. 3B shows a cross section through the useful layer of the cork board; and

FIG. 3c shows a plan view onto the floor covering which is constructed from a plurality of cork boards.

As a matter of principle, same parts are provided with same reference signs in the figures.

### Implementing the Invention

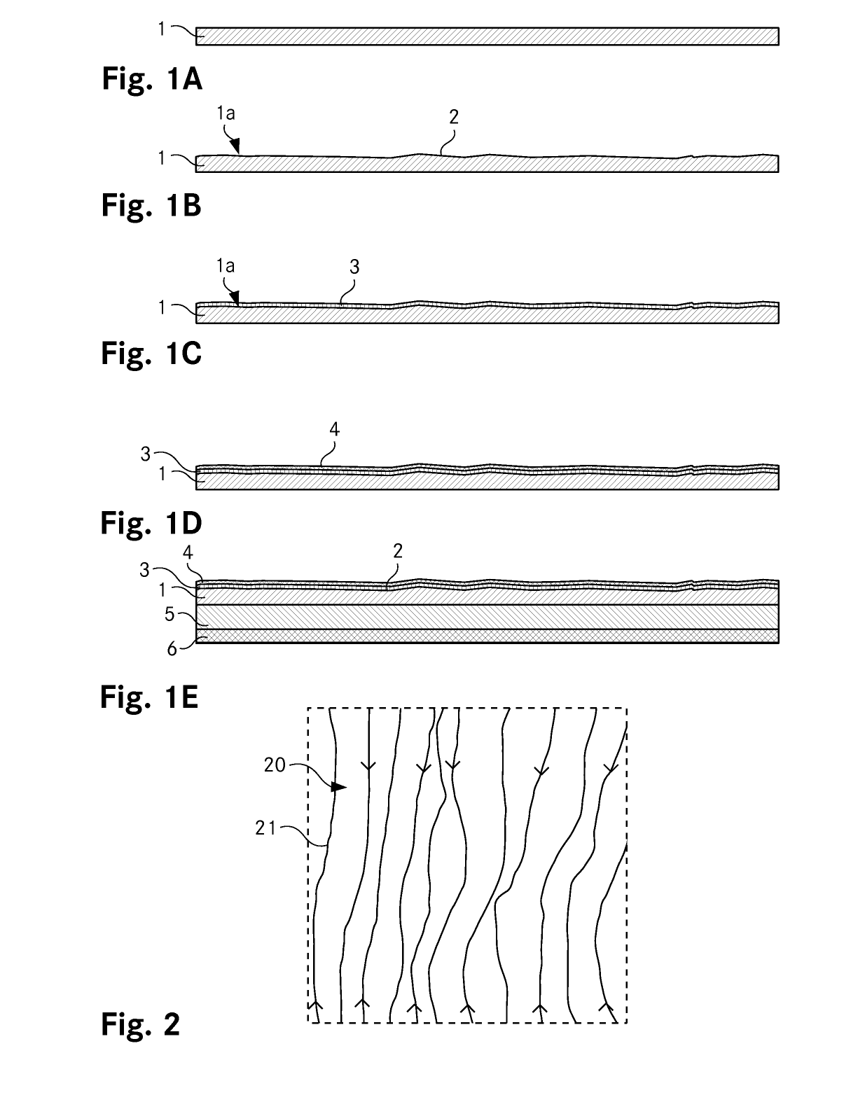

FIGS. 1A-E show vertical cross sections through a floor covering according to the invention, in various stages of manufacture. FIG. 1A shows a layer 1 from cork, having a constant thickness, 3 mm for example. In particular, a layer made from cork granulate having a modest grain size is used, such that a smooth surface, which is printable according to the generation of surface structures according to the invention and which substantially shows the surface obtained by the structuring carried out, not influenced in an esthetic manner by the granularity of the granulate, results.

A structuring 2 is now introduced into the upper main face 1a of the layer 1 (see FIG. 1B). To this end, a material-removing method is employed. In particular, a CNC-controlled installation, by way of which one or more sanding disks can be moved onto arbitrary surface positions of the layer 1 and which enable arbitrary plunging of the sanding disks into the layer 1, is employed. Depending on the geometry of the sanding disk, rotation of the sanding disk about a vertical axis, optionally also about a horizontal axis in addition thereto, may be enabled. By way of the sanding disk or the sanding disks, respectively, desired structuring 2 in the main face 1a of the layer 1 may thus be generated. The depth of the structured elements of the structuring 2 in the illustrated example is 0.1 to 0.3 mm. The structuring replicates the grain structure 20 of a wood board, for example, as is shown in the schematic plan view of FIG. 2: individual depressions 21 along the imaginary grain structure 20 are generated with the aid of a sanding disk. To this end, the sanding disk is lowered into the layer 1 at the start of a depression to be generated, then moved along the predefined line of the grain structure 20, and finally raised again until the sanding disk loses contact with the layer 1. In order to save time, adjacent depressions 21 are generated in each case in an opposing direction, as is indicated by the arrows in FIG. 2.

Next, the structured main face 1a of the layer 1 is printed by way of an ink-jet printing method, such that a printed layer 3 is formed (cf. FIG. 1C). After printing, and after a drying period which depends on the printing method and the employed ink, a protective layer 4, in particular a water-based protective varnish having proportions of acrylic and polyurethane, is applied onto the printed layer 3. The situation illustrated in FIG. 1D results.

Now, the layer 1, with the printed layer 3 and the protective layer 4, is adhesively bonded onto a 9 mm thick board 5 from HDF. Subsequently, elements for a tongue-and-groove connection of adjacent boards, of the type of a so-called “click connection”, are routed into the edge. Finally, a 1.5 mm thick cork sub layer 6 is adhesively bonded onto the lower side of the board 5 from HDF. Said cork sub layer 6 serves in particular for damping tread.

The finished layered system advantageously forms boards of a predefined size which, owing to the connection elements, can then be interconnected in a simple manner to form a flooring.

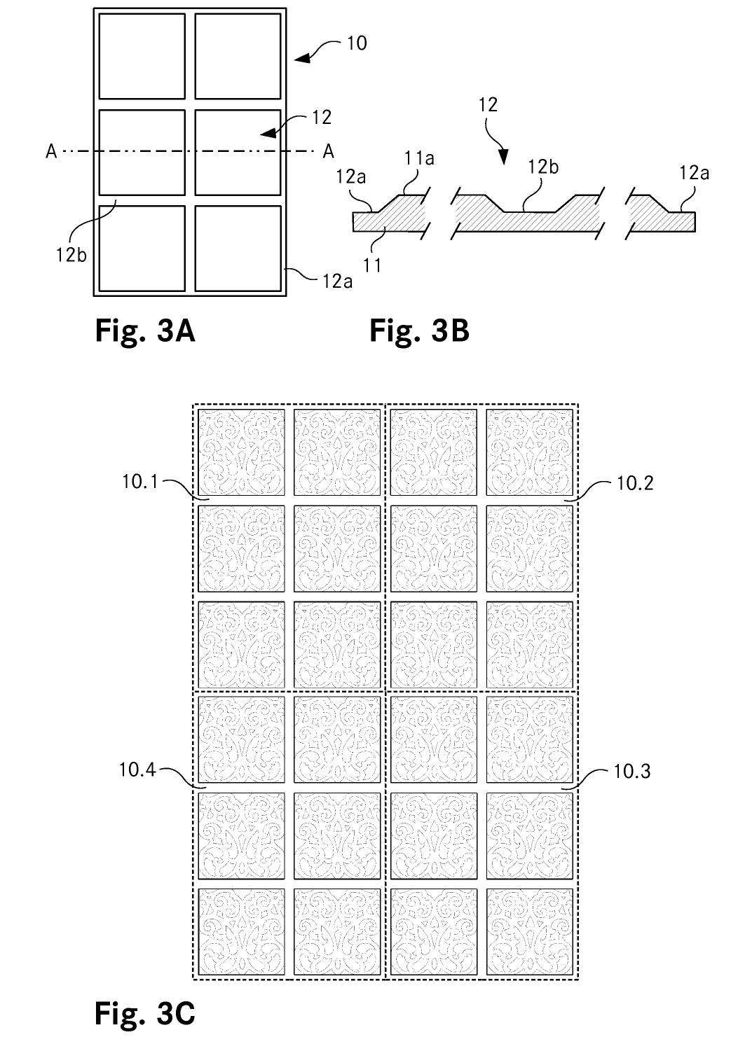

FIG. 3A shows a plan view onto a structured cork board for a floor covering according to the invention. FIG. 3B shows a vertical cross section through the useful layer of the cork board, along the line A-A indicated in FIG. 3A. FIG. 3C shows a plan view onto the floor covering which is constructed from a plurality of cork boards.

The cork board 10 is composed of a layered system as has been described above in the context of FIG. 1. The structuring 12 which has been introduced into the useful layer 11 comprises an encircling, outer depression 12a which is trough-like and adjoins the periphery of the cork board 10, and inner, trough-like depressions 12b which run transversely to the corresponding periphery and which intersect at an angle of 90°. The outer depression 12a comprises a wall which, emanating from the main face 11a of the useful layer, runs obliquely into the face, and a flat base extending parallel with the main face 11a, which extends to the periphery of the cork board 10. The inner depressions 12b comprise a base which, on both sides, is enclosed by walls, the angle of inclination of the walls and the depth of the outer and inner depressions 12a, 12b being identical, the width of the base in the case of the inner depressions 12b being double as in the case of the outer depressions 12a. In the case of the illustrated example, the cork board 10, on account of the inner depressions 12b, is subdivided into a total of six square part-regions. As is illustrated in FIG. 3C, the cork plate 10 is subsequently provided with a print, as has been described above. This print is selected such that the square part-regions are printed using one pattern, while the trough-like depressions 12a, 12b display a uniform color.

If, as shown in FIG. 3C, a plurality of the cork boards 10.1 . . . 10.4 are now directly fastened to one another, a regular geometry having in each case trough-like depressions of the same size between the square part-regions results. This geometry continues beyond the connecting edges of adjoining boards. Since the joint between the adjoining boards runs in the base of the trough-like outer depressions 12a, said joint is practically invisible.

The invention is not limited to the illustrated exemplary embodiments. In particular, the layered construction of the cork boards and the geometry of the structuring may be selected so as to be different. Moreover, many material-removing methods are employable, also in combination, for the manufacture of the structuring.

In summary it is to be stated that the invention achieves a method for working a useful surface of a floor covering, which achieves wider possibilities for influencing the visual impression of cork floors.

1. Method for working a useful surface of a floor covering, comprising the following steps:
a) introducing structures into a planar cork material, by way of a material-removing method;
b) printing the structured cork material by way of a digital printing method; and
c) applying a protective layer onto the printed structured cork material.

2. Method according to claim 1, wherein the structures comprise structural elements having a depth of 0.05 to 2.0 mm.

3. Method according to claim 1, wherein the structures comprise elongate structural elements having a width of 1 to 30 mm.

4. Method according to claim 1, wherein the material-removing method acts in regions on the planar cork material.

5. Method according to claim 1, wherein during printing a printed pattern which is aligned in relation to the introduced structures is generated.

6. Method according to claim 1, wherein during printing a printed pattern which is independent of the introduced structures is generated.

7. Method according to claim 1, wherein the material-removing method is performed in a CNC-controlled manner.

8. Method according to claim 1, wherein the material-removing method is a routing, sanding, or planing method.

9. Method according to claim 1, wherein during application of the protective layer, or in a subsequent step, a varnish layer is applied and structured.

10. Floor covering, manufacturable by a method according to claim 1, comprising:
a) a useful surface from a planar cork material, wherein the useful surface is provided with structures generated by a material-removing method;
b) a printed layer which is applied onto the structured useful surface;
c) a protective layer which is applied onto the printed layer.

11. Floor covering according to claim 10, wherein a thickness of the planar cork material is 1 to 5, preferably 2 to 4 mm.

12. Floor covering according to claim 10, comprising a dimensionally stable layer onto which the useful surface is applied.

13. Floor covering according to claim 12, wherein the floor covering comprises a plurality of boards, wherein the dimensionally stable layer in peripheral regions of the boards comprises mutually interacting fastening elements.

14. Floor covering according to claim 13, wherein the structures comprise straight, elongate, trough-like structures in a regular arrangement, wherein the arrangement is selected such that the peripheral regions of the boards at least in part run along the trough-like structures.

15. Method according to claim 2, wherein during printing a printed pattern which is independent of the introduced structures is generated.

16. Method according to claim 3, wherein during printing a printed pattern which is independent of the introduced structures is generated.

17. Method according to claim 4, wherein during printing a printed pattern which is independent of the introduced structures is generated.
